(19) United States
(12) Patent Application Publication
(10) Pub. No.: US 2016/0346944 A1
(43) Pub. Date: Dec. 1, 2016

(54) Razor With Cleaning Adjustment

(71) Applicant: Shayan Sadrialaei, Houston, TX (US)

(72) Inventor: Shayan Sadrialaei, Houston, TX (US)

(21) Appl. No.: 14/726,047

(22) Filed: May 29, 2015

(51) Int. Cl. B26B 21/40; B26B 21/22

(52) U.S. Cl. CPC B26B 21/4062; B26B 21/22

(57) ABSTRACT

A razor having a mechanism by which the user can adjust the angle and position of razor blades into a cleaning position and then return the blades to a shaving position. The blades are angled apart to allow for ease of cleaning, then returned to their original close positions to allow the lifting and cutting of hair.

### BACKGROUND OF THE INVENTION

### Background of the Invention

This invention generally relates to safety razors. More particularly, the present invention is directed to the adjustment of blade position in multiblade razors for the purposes of cleaning.

The multiblade razor has been used in the past to allow for a closer shave than could be achieved by single blade razors. In a multiblade razor, the blades are precisely spaced such that the first blade passing over the hair lifts the hair out of the skin while cutting. The second blade then follows behind, cutting the hair closer to the root while it is exposed from the pull of the first blade. Additional blades can be used to ensure consistency and lift the hairs further from the skin for closer cutting.

The use of multiple blades comes with the disadvantage that the close space between the blades tends to accumulate hair and skin debris, which can be difficult to remove and clean due to the narrowness of the opening. This accumulated material is unsanitary as it breeds bacteria.

Previous technology in the industry has allowed adjustment of the angle of a single blade. What is desired is a razor where multiple blades may be adjusted for cleaning and then returned to the precise spacing and angling required for lifting and cutting the hairs.

### BRIEF DESCRIPTION OF THE DRAWINGS

FIG. 1A illustrates a razor in which the angle of the blades is adjustable by a rotating mechanism in an exemplary embodiment of the invention.

FIG. 1B illustrates the movement of the rotating mechanism.

FIGS. 2A-2C illustrate the relationship between the movement of the rotating mechanism and the angle of the blades.

FIG. 3A illustrates the position of the blades within the head of the razor when the blades are in a shaving position.

FIG. 3B illustrates the position of the blades within the head of the razor when the blades are in a cleaning position.

FIG. 3C illustrates the association between the rotating mechanism and the blades which allows adjustment of the angle of the blades.

FIGS. 4A-4B illustrate the head of the blade and the relative position of the blades when the razor is in a shaving position.

FIGS. 5A-5B illustrate the head of the blade and the relative position of the blades when the razor is in a cleaning position.

FIG. 6 illustrates an alternative embodiment of a razor where the angle of the blades is adjusted by raising and lowering one edge of the blade in an exemplary embodiment of the invention.

FIGS. 7A-7C illustrate how the blades are adjusted from shaving position to cleaning position and returned to cleaning position by raising or lowering one edge of the blades.

FIGS. 8A and 8C illustrate the position of the blades within the head of the razor when the blades are in a shaving position.

FIGS. 9A and 9C illustrate the position of the blades within the head of the razor when the blades are in a cleaning position.

FIG. 10A illustrates an alternative embodiment of a razor where the position of the blades is adjusted by the use of a yoke which compresses or relaxes springs placed within the blade stack in an exemplary embodiment of the invention.

FIG. 10B illustrates the internals of the yoke and blade stack.

FIGS. 11A-11C illustrate blade adjustment between shaving position and cleaning position.

FIG. 12A illustrates the position of the blade stack within the head of the razor when the blades are in a shaving position.

FIG. 12B illustrates the position of the blade stack within the head of the razor when the blades are in a cleaning position.

### DETAILED DESCRIPTION OF THE PREFERRED EMBODIMENTS

The invention is designed to allow for adjustment between a shaving position and a cleaning position. In the shaving position, the blades are spaced close together. If the blades are close together in a precise formation which allows for lifting and cutting of the hairs. In multiblade razors, the spacing is often designed so that the first blade catches on the hair and pulls the hair outwards from the follicle. The second blade cuts the hair lifted and pulled by the first blade and may also further lift and pull the hair for further cutting by additional blades. The lifting of the hairs from the follicles results in a closer shave.

If the blades are spaced close together such as in the shaving position, there is a drawback that the blades will accumulate hair and dead skin, which is unsanitary and interferes with cutting. To remedy this, the current razor is designed to be adjustable into a cleaning position. In this position, the blades are spaced in such a way that water may more easily flow through and remove accumulated debris. This can be accomplished in several ways. The blades may be spread apart while remaining parallel to one another. The blades may be fanned open so that the distance between the cutting edges of the blades increases. The blades may be turned within the head of the razor so that the thin cutting edges of the blades are perpendicular to the back of the head, allowing water to more easily enter the back of the cavity between the blades.

The blades may be adjusted by the user by various means. The blades may be anchored to a rotatable mechanism such as a pivot which the user may manipulate. A lever may be used as a mechanism to apply torque to the pivots. In another embodiment, the blades may be attached at the corners toward or away from the cutting edge to a sliding bar which may be moved up or down to adjust the angle of the blades relative to the head. In another embodiment, the blades may be separated from one another by compressible springs. The user may apply pressure to the springs to compress them and decrease the distance between the blades. In another embodiment, the blades may be fanned outward by a mechanism which pulls the cutting edges of the blades apart from one another while leaving the back edges in their original position.

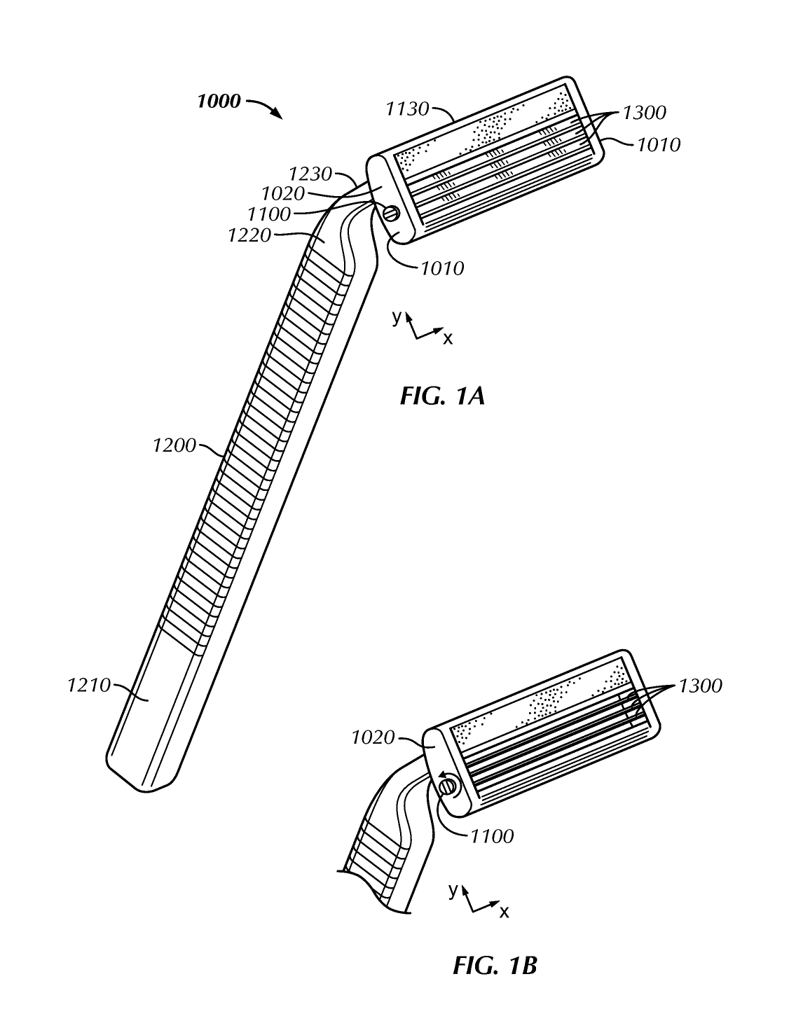

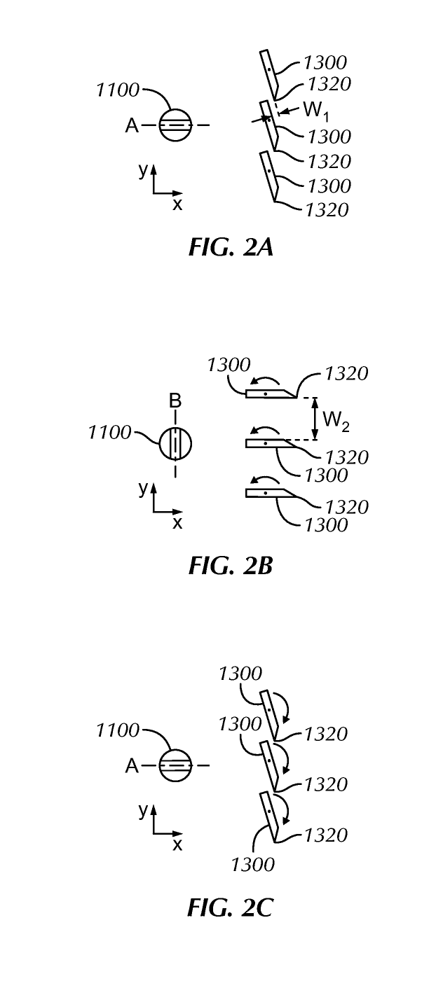

Referring to FIG. 1, the first embodiment is a razor which contains a handle (1200) with a first end (1210) and a second end (1220). The second end (1220) is coupled to a head (1000) at a head coupling point (1230). The head (1000) of the razor contains a first and second endpiece (1010) which are mirror images of one another. These endpieces (1010) are coupled to opposite ends of a crosspiece (1130), which is coupled to the handle (1200) at the head coupling point (1230). The endpieces (1010) and crosspiece (1130) are coupled in a manner which allows them to enclose a plurality of blades (1300). The blade (1300) contains a cutting edge (1320, designated in FIG. 2) and two anchoring ends (1310, not designated).

Referring to FIG. 2, when the lever (1100) is rotated, the blades (1300) are rotated so that the distance between the cutting edges (1320) increases or decreases. This allows the razor to be set into a shaving position where the distance (W₁) between the cutting edges (1320) is shorter and a cleaning position where the distance (W₂) between the cutting edges (1320) is significantly larger.

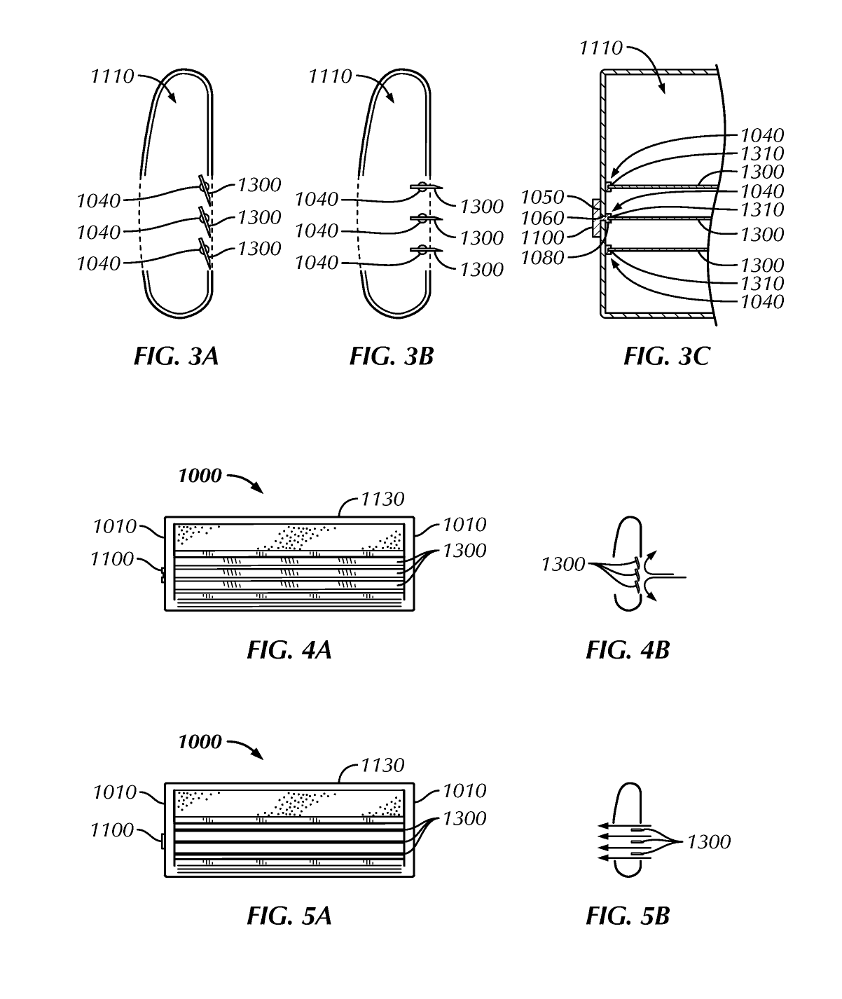

Referring to FIG. 3, at the ends farthest from the the crosspiece, the endpieces terminate in an endplate. A plurality of pivot holes are drilled through the endplate. Within the enclosed area created by the coupling of the endpieces (1010) to the crosspiece (1130), adjacent to the endplate (1020), there is a back channel (1110). The back channel may contain one or more channels for funneling water through the blades to promote cleaning. A plurality of pivots (1040) are inserted through the pivot holes (1030) so that their blade engaging ends (1080) project into this back channel (1110). In another embodiment, the back channel may be utilized to collect debris until rinsed to prevent debris from interfering with a proper shave.

The pivots (1040) contain pins with a lever engaging end (1060) and a blade engaging end (1080). The blade engaging end (1080) contains a blade engaging slot (1090). The anchoring edges (1310) of the blade (1300) are inserted into the blade engaging slots of the pivots (1040) inserted into the first and second endpieces (1010). The lever engaging end (1060) of the pin (1050) is coupled at a lever connection point (1070) to a lever (1100). This lever (1100) can be manipulated by the user to rotate the pivot (1040), adjusting the angle of the blade (1300). One skilled in the art would appreciate that other rotating mechanisms may be substituted for the lever. This allows the razor to be set into a shaving position or into a blade cleaning position.

Referring to FIGS. 4 and 5, when the razor is in a shaving position, the blades (1300) are angled so that the distance between the blades (1300) is small, allowing very little space for water to enter and for debris to exit. In the cleaning position the blades (1300) are angled so that the distance between the blades (1300) is large and water may flow freely through the razor to remove debris.

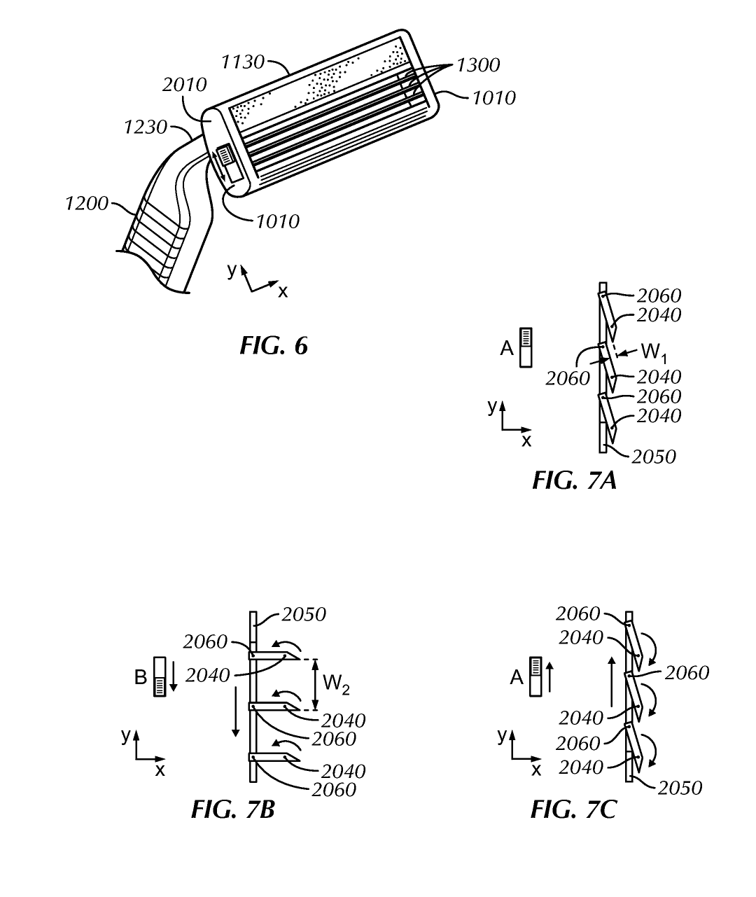

Referring to FIG. 6, in another embodiment, the invention is a razor which contains a handle (1200). The handle (1200) is coupled to a head (1000, not designated) at a head coupling point (1230). The head (1000) of the razor contains a first and second endpiece (1010) which are mirror images of one another. These endpieces (1010) are coupled to opposite ends of a crosspiece (1130), which is coupled to the handle (1200) at the head coupling point (1230). The endpieces (1010) and crosspiece (1130) are coupled in a manner which allows them to enclose a plurality of blades (1300) which are oriented parallel to the endpiece. The blade (1300) contains a cutting edge (1320) and two anchoring ends (1310).

Referring to FIG. 7, the slide bar (2050) contains a plurality of back blade pivots (2060). Each back blade pivot (2060) and front blade pivot (2040) is configured so that the blade can be shifted between a blade cleaning position and shaving position. The distance (W₁) between the blades in shaving position is substantially smaller than the distance (W₂) between the blades in cleaning position.

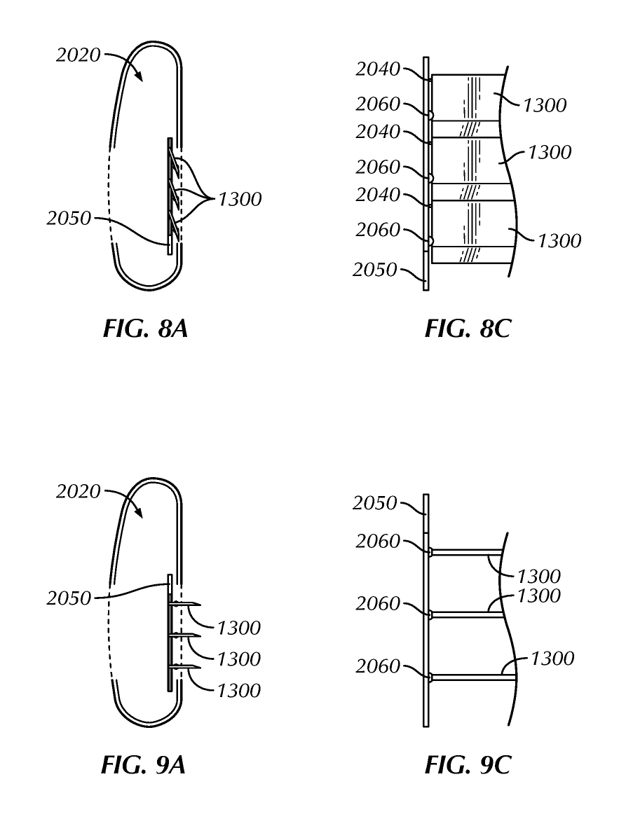

Referring to FIGS. 8 and 9, within the head (1000, not designated) of the razor there is a slide channel (2020, designated 1110 in previous embodiments) A plurality of front blade pivots (2040) are mounted in the portion of the slide channel (2020) closer to the cutting edges (1320, not designated) of the blade. A plurality of back blade pivots (2060) are located within the portion of the slide channel (2020) farther from the cutting edges (1320, not designated) of the blade. Within the slide channel (2020) there is a slide bar (2050), which can be manipulated by the user such that it may be repositioned vertically within the slide channel (2020). The slide bar (2020) is the mounting point of one set of the pivots, while the other set of pivots is coupled to the side of the slide channel (2020). The set of pivots mounted on the slide bar (2020) can move freely when the slide bar (2020) is moved, while the other set remains in its original position. This allows the angle of the blades (1300) to be adjusted by the user between a shaving position and a mounting position.

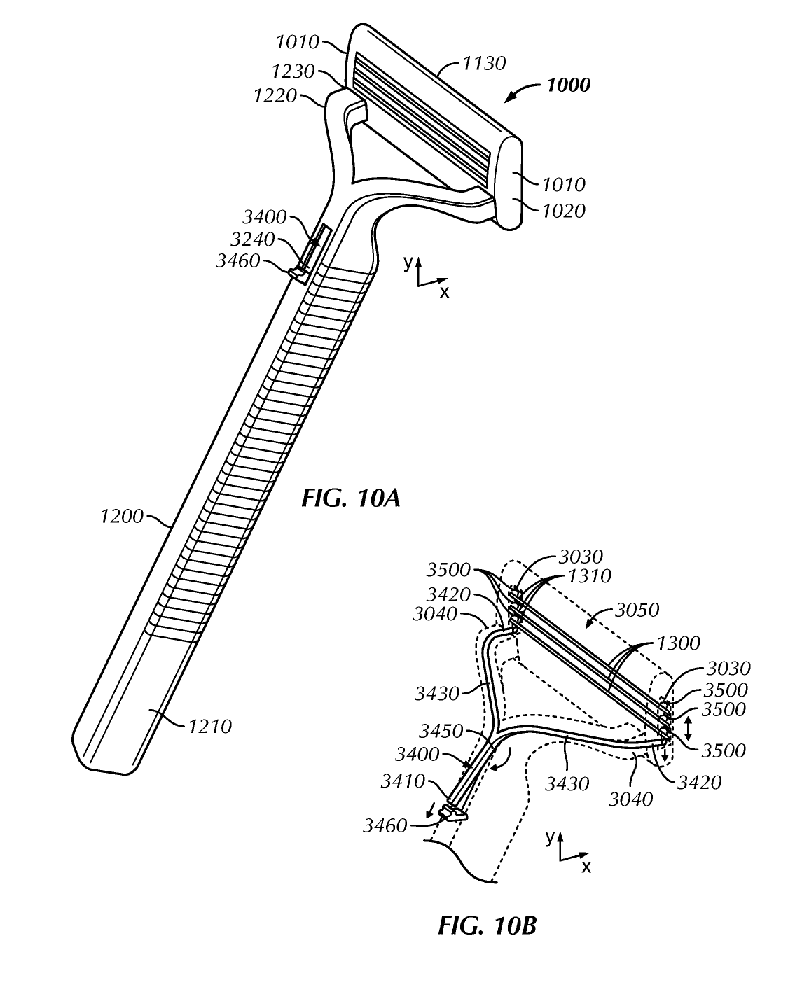

Referring to FIG. 10, in another embodiment, the invention is a razor which contains a handle (1200) with a first end (1210) and a second end (1220). The second end (1220) is coupled to a head (1000) at a head coupling point (1230). The handle (1200) is coupled to a yoke (3400) at a yoke coupling point (3240). The head (1000) of the razor contains a first and second endpiece (1010) which are mirror images of one another. These endpieces (1010) are coupled to opposite ends of a crosspiece (1130), which is coupled to the handle (1200) at the head coupling point (1230). The endpieces (1010) and crosspiece (1130) are coupled in a manner which allows them to enclose a plurality of blades (1300). The blade (1300) contains a cutting edge (1320, not designated) and two anchoring ends (1310).

The yoke (3400) has a handle coupling end (3410) and an endpiece coupling end (3420). The endpiece coupling end (3420) has two prongs (3430). The prongs (3430) connect to yoke coupling slots (3040) on the endpieces (1010) of the head (1000). The yoke has a pivot point (3450) midway between its handle coupling end (3410) and its endpiece coupling end (3420). The yoke (3400) may have a toggle (3460) at the handle coupling end (3410).

The endpieces (1010) of the razor terminate at the end opposite the crosspiece (1130) in a back plate (3010). The head (1000) contains a yoke coupling slot (3040) which is configured to receive a prong (3430) of the yoke (3400). Within the enclosed area (3050) created by the coupling of the endpieces (1010) to the crosspiece (1130), adjacent to the endplate (1020), there is a spring channel (3030). The yoke coupling slot (3040) is positioned so that the prongs (3430) may enter through the back plate (3010) and project into the spring channel (3030) Within the enclosed area (3050) created by the coupling of the crosspiece (1130) to the endpieces (1010), on the sides of the endpiece (1010) coupled to the crosspiece (1130), a plurality of leaf springs (3500) are positioned in the spring channel (3030) between the anchoring edges (1310) of the blades (1300).

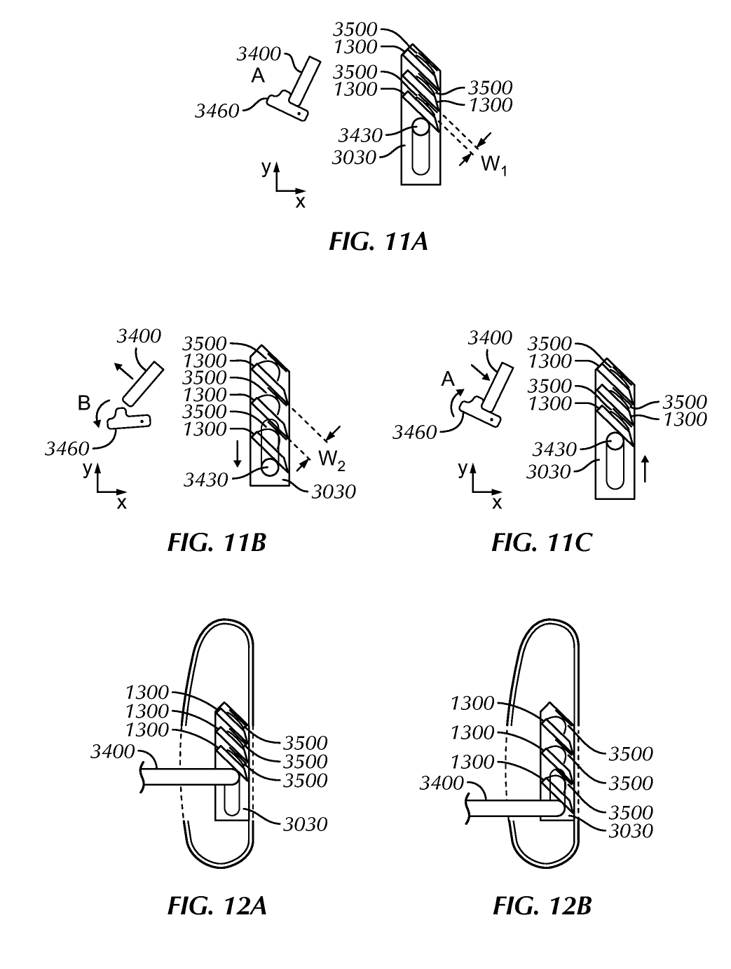

Referring to FIGS. 11 and 12, when the yoke (3400) position is adjusted by the user, the ends of the prongs (3430) projecting through the yoke coupling slots (3040) of the endpieces (1010) compress the lower portions of the leaf springs (3500), bringing the blades (1300) into close proximity for shaving. When the pressure is removed from the leaf springs (3500), they decompress, separating the blades (1300) and setting the razor into cleaning position.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Additionally some elements illustrated in the singularity may actually be implemented in a plurality. Further, some element illustrated in the plurality could actually vary in count. Further, some elements illustrated in one form could actually vary in detail. Further yet, specific numerical data values (such as specific quantities, numbers, categories, etc.) or other specific information should be interpreted as illustrative for discussing exemplary embodiments. Such specific information is not provided to limit the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A razor with a plurality of blades, the blades being movable between a closely aligned shaving position and a wider spaced cleaning position.

2. The razor of claim 1, wherein moving the blades comprises;
stacking the blades with spring components between at least one edge of the blade stack; and
alternating the springs between a compressed and expanded position.

3. The razor of claim 2, wherein alternating between spring positions is accomplished by a yoke affixed to the handle and pressing on one of the end blades of the stack, the other end being retained by a fixed component of the razor head.

4. The razor of claim 1, wherein moving the blades between positions comprises;
affixing the rear edge of the blades; and
fanning the front edge of the blades to increase the space there between.

5. The razor of claim 4 wherein moving the blades comprises;
pivotably securing one edge of the blades; and
allowing the distal edge to raise or lower to vary the distance between the edges of the blades.

6. The razor of claim 5 where raising and lowering one edge of the blades is accomplished by a fixture on the side of the blades near the edge which is repositionable along a path which is parallel to the rear plane of the blade stack.

7. The razor of claim 1 where the blades are coupled to a rotating mechanism which may be turned to place the blade in shaving or cleaning position.

8. An apparatus for shaving comprising;
a head comprising;
a plurality of blades,
the blades being adjustable in angle relative to one another;
a crosspiece,
the crosspiece being coupled to the endpieces;
endpieces,
where the blades are coupled at their anchoring edges to a mechanism allowing adjustment of the angle of the blades between a shaving position and a cleaning position,
a handle having first and second ends,
the second end being coupled to the head;

9. A method for shaving, comprising the steps of
(a) placing the razor in a closely aligned shaving position for shaving,
(b) placing the razor in a wider spaced cleaning position, and
(c) returning the razor to a closely aligned shaving position.

10. The method of claim 9, wherein changing the blade positions comprises compressing and expanding a set of springs stacked between at least one edge of the blade stack

11. The method of claim 10, wherein the compression and expansion of the springs is accomplished by a yoke affixed to the handle and pressing on one of the end blades of the stack, the other end being retained by a fixed component of the razor head.

12. The method of claim 9, wherein changing the blade positions comprises fanning one edge of the blades to increase the space there between.

13. The method of claim 12 wherein fanning the blades comprises;
pivotably securing one edge of the blades; and
raising or lowering the distal edge to vary the distance between the edges of the blades

14. The method of claim 13 where raising and lowering one edge of the blades is accomplished by a fixture on the side of the blades near the edge which is repositionable along a path which is parallel to the rear plane of the blade stack.

15. The method of claim 9 wherein changing the blade positions comprises manipulation of a rotating mechanism which may be turned to place the blade in the closely aligned shaving and the wider spaced cleaning position cleaning position.
